(19) United States
(12) Patent Application Publication
(10) Pub. No.: US 2018/0137158 A1
(43) Pub. Date: May 17, 2018

(54) FOREIGN KEY LEARNER

(71) Applicant: SAP SE, Walldorf (DE)

(72) Inventors: Florian Hoffmann, Ladenburg (DE); José Prados, Heidelberg (DE)

(21) Appl. No.: 15/350,350

(22) Filed: Nov. 14, 2016

(51) Int. Cl. G06F 17/30; G06F 3/0484

(52) U.S. Cl. CPC G06F 17/30339; G06F 17/30315; G06F 17/30507; G06F 3/0484

(57) ABSTRACT

Provided are devices and methods for automated detection of foreign keys linking database tables together. In one example, a device includes a processor that receives a plurality of tables of data, and processes an automated foreign key learning application with respect to the plurality of tables. According to various embodiments, the foreign key learning application identifies at least one foreign key that links a list of columns of a first table to a list of columns of a second table. Furthermore, an output may display a user interface including an identification of the foreign key, the first table, and the second table. Based on the system and methods described herein, the detection of foreign keys may be performed automatically instead of by manual user input thus saving significant time and expense.

### BACKGROUND

A foreign key is a column or group of columns in a relational database table that provides a link between data of two tables. For example, a foreign key is typically defined in a second table (e.g., a child table) but may refer to a primary key in a first table (e.g., a parent table). The foreign key acts as a cross-reference between the tables because the foreign key references the primary key of another table, thereby establishing a link between them. For the most part, tables in a relational database system adhere to the foreign key concept. In complex databases and data warehouses, data from within a domain is typically added to multiple tables, thus maintaining a relationship between them. As another example, in the context of relational databases, a foreign key may be a field, or multiple fields, in one table that uniquely identifies a row or column of another table. Most applications that operate on specific data know the structure of their data (and the associated/linked data tables). For example, a business application may operate on a large set of database tables that have structure the application knows very well.

However, some types of applications such as analytical applications are designed specifically to operate on data with an unknown structure. This type of application must learn about the data it is operating on. In order to better process data, these types of applications may require that the user of the data provide information about the structure of the data through metadata. For example, analytical applications may copy the data in an Extract-Transform-Load (ETL) process and bring the data into a different form, such as data cubes or graph tables. Other applications may use database views to store the data in its original format but transform the data on-the-fly when needed. Still other applications may require that the user create a vocabulary, ontology, or knowledge graph that explains how to interpret the data. As a result, generating the metadata is a manual process that can be difficult, tedious, and error-prone. As one example, setting up a complete ETL process typically requires system configuration capabilities, administration authorization, and in-depth business knowledge. The process can take days or even weeks of work until the result is satisfactory. Furthermore, the process usually needs to be performed multiple times for the same application because separate features access the data in different ways. For example, a fraud management application can require a user to create a field catalog, several kinds of database views, a multitude of database procedures, and a vocabulary, all explaining the same business data in different ways to different features of the application.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a metadata architecture for database tables in accordance with an example embodiment.

FIG. 2 is a diagram illustrating a foreign key learning application in accordance with an example embodiment.

FIG. 3 is a diagram illustrating a foreign key learning process in accordance with an example embodiment.

FIG. 4 is a diagram illustrating an inclusion-based discoverer of a foreign key learning process in accordance with an example embodiment.

FIG. 5 is a diagram illustrating a method for detecting foreign keys in accordance with an example embodiment.

FIG. 6 is a diagram illustrating a device for detecting foreign keys in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a foreign key learning tool for determining how data is linked together. The foreign key learner may auto-learn how tables of data are associated with each other thus making it easier for the foreign key learner to operate on the data and without requiring a user to manually enter information about the data. The foreign key learner may auto detect relationships between tables of data based on various determiners that are designed to find foreign keys within the data. The example embodiments can simultaneously scan or run discoverers on multiple data tables (e.g., two, ten, fifty, etc.) and find relationships between the any of the tables. The algorithm may output a list of potential candidate matches (i.e., foreign keys) and each candidate may include an identification of two tables, that may be designated as a child and a parent table, and list of columns from each table that are detected as being related with one another plus a confidence level that the two columns are related.

Many software applications work on unknown data. These applications are not limited to a particular industry or field and may include such fields as healthcare, retail, insurance, and many other business types. Typically, a user familiar with the data is required to provide information about the data to help assist in processing the data. For example, the user may enter information about tables in the data, how the tables are linked, information about data included in the tables, and the like. Recently, the amount of information required of the user has grown significantly as a result of the complexity of data processing and analytics being performed. The example embodiments relieve this process for users by auto-determining how data is linked together. For example, relationships between tables of data may be learned by one or more foreign key discoverers.

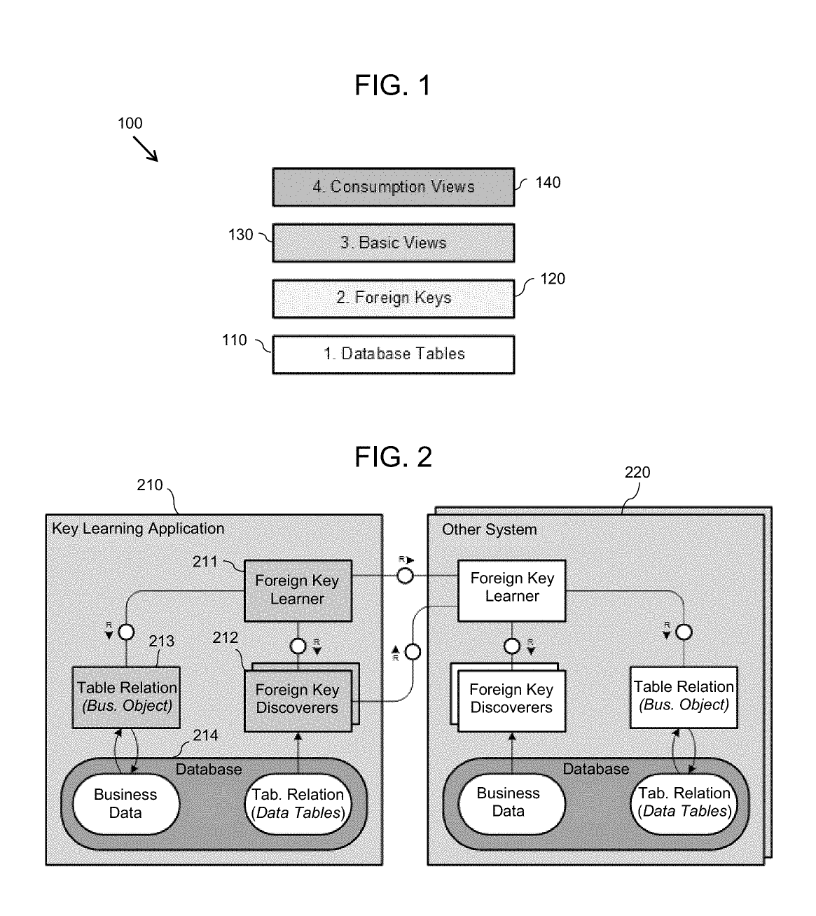

FIG. 1 illustrates a metadata based architecture 100 for operating on database tables in accordance with an example embodiment. Referring to FIG. 1, the metadata based architecture 100 has four layers including database tables 110, foreign keys 120, basic views 130, and consumption views 140. In this example, the lowermost layer is the raw data itself (i.e., the database tables 110). For each consumer, client, user or the like, the database tables layer 110 may include a plurality of tables, for example, a table for business partners and another table for addresses. On top of the database tables layer 110 is the layer of foreign keys 120 which is the metadata that is automatically detected according to various embodiments. Staying with the same example, the foreign keys 120 may describe the data relationships between the business partners and their addresses. On top of the foreign keys 120 is a layer for basic views 130. The basic views 130 may publish basic objects of interest, for example, a database view that joins business partners to their primary address of residence. The topmost layer is the consumption views 140 that shape the data, for example, in order to represent the data in a user interface that is displayed on a screen of a display device. For example, a database view may concatenate multiple name and address fields to display the data more efficiently and in a better format.

The example embodiments provide a foreign key learner that operates within the foreign keys layer 120 of the metadata-based architecture 100. While this layer is a lower layer, this is also the layer that requires most work because the foreign keys are numerous and hard to spot without prior knowledge. For example, an application can contain hundreds of thousands of foreign key relationships or more. Also, when the foreign key metadata is detected, the generating and the processing performed on the layers above the foreign keys layer 120 becomes easier (less computation) and quicker (faster processing). The foreign key learner may automatically detect and output a list of multiple columns from each table that are detected as being related with one another plus a confidence level that each respective pair of columns are related.

FIG. 2 illustrates a foreign key learning application 210 in accordance with an example embodiment. Referring to FIG. 2, the foreign key learning application 210 may include software, programs, code, modules, and the like, capable of performing automated foreign key detection (e.g., learning) from database tables. For example, the foreign key learning application 210 may speed up the configuration of applications that process data in relational databases with unknown structure. The foreign key learning application 210 may automatically identify foreign key relationships between database tables based on one or more foreign key discoverers which are further described in some of the examples herein. The identified foreign key relationships can be used in multiple ways, for example, graph engines associated with the database may parse these relations directly as edges in network graphs, development tools may use them for value assistance, code completion, and type-ahead searching to support the user in creating artefacts such as database views more quickly, and advanced processes may use the relationships to automatically create these artefacts on their own.

In the example of FIG. 2, the foreign key learning application 210 includes a number of modules including a foreign key learning controller 211, one or more foreign key discoverers 212, table relations 213, and a database 214. Here, the foreign key learning controller 211 is the main entry point of the system and may be used to control the other modules. The foreign key learning controller 211 may call one or more foreign key discoverers 212 to find or otherwise identify new foreign keys. After completion, the foreign key learning controller 211 consolidates the results of the foreign key identification, and forwards the consolidated foreign keys to the table relation business object 213. In some examples, the foreign key learning application 210 is also able to communicate the identified foreign keys to other foreign key learning applications 220 executing in the same system or in other systems.

According to various embodiments, the foreign key discoverers 212 may apply logical calculations, apply statistical methods, read metadata, push and pull data from other systems, and the like, to find new foreign keys from database tables. In some examples, the foreign key discoverers 212 can communicate with foreign key learners in other systems to retrieve foreign keys related to the database tables that have been identified by the other systems. The database 214 includes business data and database tables that are organized in schemas. The data within database 214 may come from applications running on the database 214, or the data may be replicated into the database from one or more other applications and/or systems that are connected thereto such as the other system 220. The table relation business object 213 may store identified foreign keys in table relation database tables of the database 214. The table relation business object 213 may also be responsible for creation, modification, deletion, and retrieval of the foreign keys.

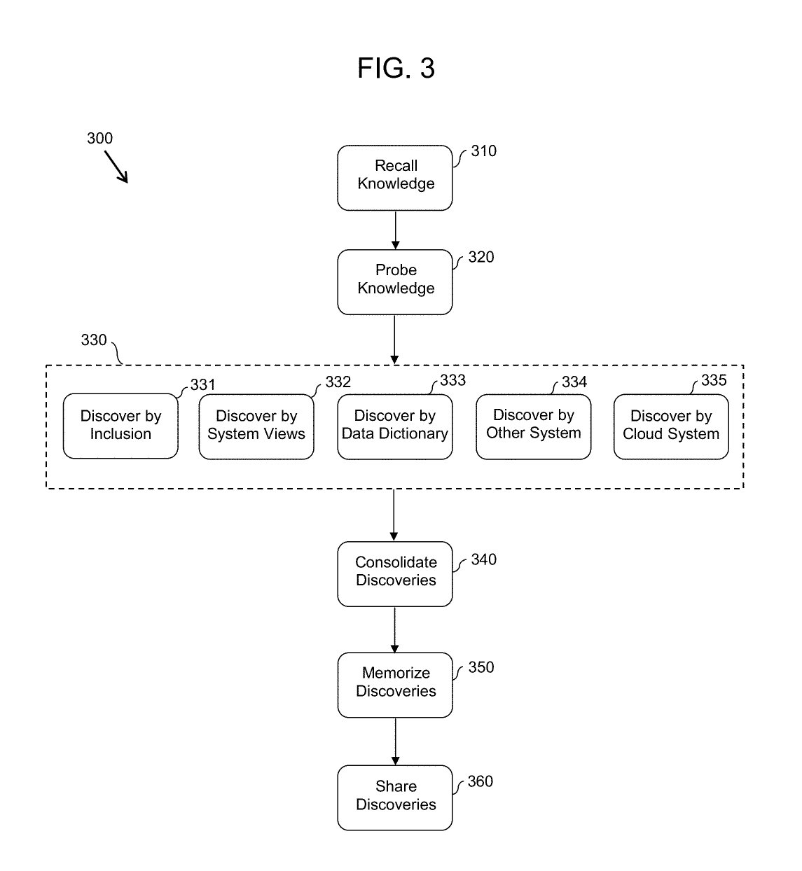

FIG. 3 illustrates a foreign key learning process 300 performed by a foreign key learning application in accordance with an example embodiment. In these examples, the foreign key learning application (i.e., foreign key learner) may receive a name of a table and return all foreign keys included in the named table that point to other tables (i.e., where the named table is a child table) and foreign keys included in other tables that point to the respective table (i.e., where the named table is the parent table). That is, the table corresponding to the name may be a source table including a foreign key that points to another table, or the table may be a target table for a foreign key included in another table that points to the target table. Referring to FIG. 3, in 310 the foreign key learner recalls what is already known about the table. For example, the foreign key learner may read a table relations store associated with the foreign key learner. If the table was analyzed before, this store may already provide foreign keys to or from the table.

In 320, the application may probe the recalled knowledge to find out whether the recalled knowledge is exhaustive and up-to-date. For example, if the recalled knowledge is found to be exhaustive, the previous analysis has looked at everything a current analysis would do or would perform. Here, if a new foreign key discovery operation has been added to the foreign key learning application or data has been newly stored in the database, new foreign keys may be discovered. The process of determining if the recalled knowledge is exhaustive includes identifying if the data has changed and also determining if all current foreign key discovery processes were previously performed and completed successfully. For example, a most recent running of a foreign key learner may be from a week ago. In this example, a user may have added a new discoverer to the group of discovery processes (e.g., discoverer operations performed in 330) of the foreign key learning application. Accordingly, when the foreign key learner is executed (e.g., current day), the foreign key learner will determine that the previous knowledge is not exhaustive because of the new discoverer that was added subsequent to the last running of the foreign key learner and which may provide yet-unknown insights.

As another example, if the recalled knowledge is found to be up-to-date, it indicates that the tables in the schema didn't change since the previous analysis was performed. However, if the tables have new data and the recalled knowledge is not up-to-date, there is a possibility new foreign keys may be discovered. In some cases this information may be hard to detect so other criteria may be used, such as previous analysis took place no more than a predetermined amount of time, for example, three weeks ago. If the recalled knowledge is both exhaustive and up-to-date, the current analysis may be skipped because the analysis will only repeat what has already been done on the same data and will not produce any new insights. Otherwise, the current analysis continues execution.

In 330, the foreign key learner calls one or more foreign key discovery processes such as foreign key discoverers 331-335. The foreign key discoverers 331-335 are designed to find foreign keys that have yet to be identified. Each foreign key discoverer 331-335 receives the table that is to be analyzed and produces a set of rated foreign keys. An example of analyzing a table “ORDERS” shown in Table 1 is further provided.

TABLE 1

| Source table | Source fields | Target table | Target fields | Rating |
|---|---|---|---|---|
| ORDERS | CLIENT, | SUPPLIERS | CLIENT, | 0.99 |
| | SUPPLIER | | SUPPLIER_ID | |
| ORDER_ITEMS | CLIENT, | ORDERS | CLIENT, | 1.00 |
| | COMPANY_CODE, | | COMPANY_CODE, | |
| | PARENT_ID | | ORDER_ID | |
| ORDERS | CLIENT, | ORDERS | CLIENT, | 0.98 |
| | COMPANY_CODE, | | COMPANY_CODE, | |
| | RELATED_ORDER | | ORDER_ID | |
| . . . | . . . | . . . | . . . | . . . |

In some examples, foreign key discoverers may work in both directions, such that the analyzed table may appear as both a source table and a target table for foreign key detection. For example, the table may appear as both a target table and a source table at the same time, if the foreign key points to the table itself. As one example, the table above gives such an “internal” foreign key in row 3, where an order in table ORDERS relates to a different order in the same table.

Furthermore, the rating is a number or other variable that indicates how confident the foreign key discoverer is that the foreign key really exists. In this example the rating ranges from 0.00 for uncertain to 1.00 for completely certain. There may be foreign key discoverers that always rate as 1.0, especially discoverers that read existing metadata about the database tables. Statistics-based or machine-learning-based discoverers however, will usually produce results with varying confidence.

In this example, the foreign key discoverers 331-335 may work independently from each other, such that they can be executed in parallel to reduce the response time of the algorithm.

That is, a plurality of discoverers from among the foreign key discoverers 331-335 may be executed simultaneously on the database tables because they can operate independently from one another. In some cases though, if the response time can be reduced by forwarding one discoverer's findings to another discoverer, this may be changed to a sequential execution. For example, if a first discoverer reads existing metadata on foreign keys from system tables in the database, these foreign keys are reliable and need not be analyzed again by a second discoverer that applies statistical analysis.

In some embodiments, the foreign key discoverers may return more information on the table relations, such as their cardinality, a description text, whether business users found the table relation useful, and the like. This is especially useful for discoverers that cooperate with other systems to discover table relations because the other systems may be given a better understanding of the context. The example embodiments include a plurality of foreign key discoverers 331-335. However, other discovery techniques may exist and the examples herein should not be construed as limiting the scope. Furthermore, the set of foreign key discoverers may be configurable, allowing a user to plug-in existing or self-developed foreign key discoverers as desired. Additional examples of each of the plurality of foreign key discoverers 331-335 are further described below. When all discoverers have completed, their results may be consolidated in 340. During the consolidation, if there are duplicate findings of a foreign key, only one of the findings may be kept such as the foreign key with the highest rating. In 350, the foreign key learner saves newly encountered foreign keys in a table relations store. The foreign key learner may also update the foreign keys that are previously known to store changes in the foreign key's rating.

After learning the foreign keys, the process 300 may optimize future analyses and enable other foreign key learners to benefit from the current findings. In 360, the foreign key learner calls other systems to tell them know about the newly identified foreign keys and any updates to previously known keys. The other systems may include other systems in the same landscape, or cloud systems, especially when the customer runs dozens of similar systems and wants to distribute findings to all of them. In this example, 360 is the inversion of discoverers 334 and 335 in which the foreign key learner pulls learnings from other systems/cloud. In contrast, in 360 the foreign key learner pushes learnings into other systems. The technology for sharing may be freely modified. For example, Remote Function Calls (RFC), Web Services, and OData Services may be used for sharing, but there are other protocols and technologies that are just as suited. Although not shown in FIG. 3, the foreign key learner may also call a search space manager to memorize the successful completion of the analysis of the table. For example, the memorizing may include inserting the table's name into a database table of analyzed tables. As another example, the current timestamp may be added to remember when the analysis was completed. Further other information may be saved as well, for example, the exact version of the foreign key learner, who started the execution, what tables were included in the database schema at the time of analysis, and the like.

In the process 300 of FIG. 3, the plurality of discoverers 331-335 performed in 330 may be executed simultaneously, sequentially, and the like. Also, one or more of the discoverers 331-335 may be omitted or may be skipped. In some cases, only one of the discoverers may be executed. Also, results generated by two or more discoverers may be combined to provide a user with a comprehensive list of foreign keys discovered through multiple discoverer operations.

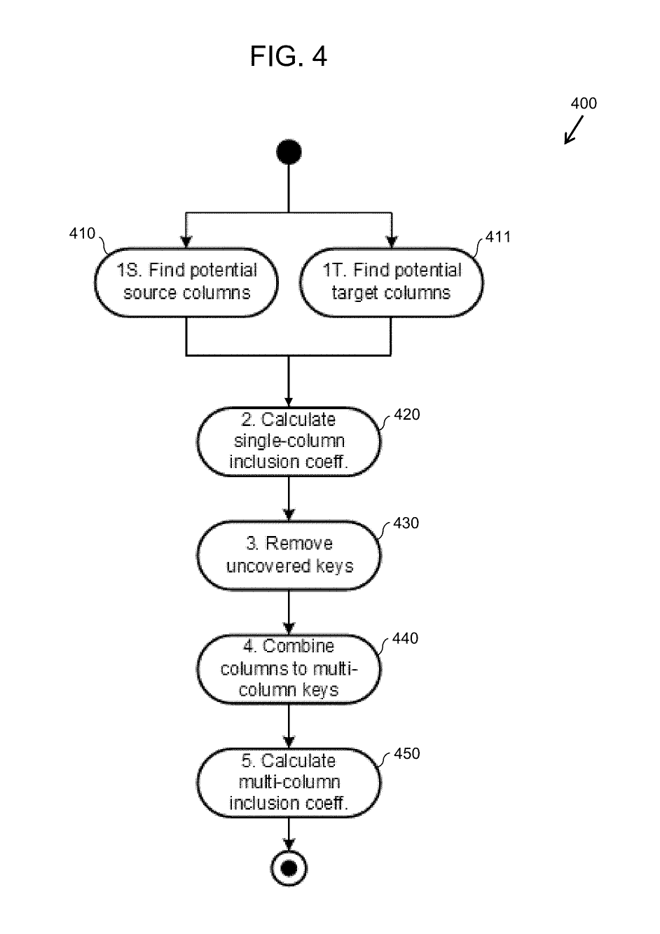

FIG. 4 illustrates an inclusion-based discoverer 331 of a foreign key learning process in accordance with an example embodiment. Referring to FIG. 4, the inclusion-based discoverer 331 discovers foreign keys by calculating inclusion coefficients between columns and sets of columns. As with all discoverers, the inclusion-based discoverer 331 receives the table to be analyzed and finds foreign keys from or to that table. Referring to FIG. 4, in 410 and 411, the inclusion-based discoverer 331 finds pairs of compatible columns. In this example, compatible means that one column can store the values of the other column. In the following example shown in Table 2, a Delivery Table and a Client Table are compared. Here, the column Delivery.Client is compatible to Partner.Client, and vice versa, because both have the same data type and length and can contain each other's values (and in fact, do). Similarly, the column Delivery.DocumentID is compatible to Partner.PartnerID. Although the second column is longer, the second column can still store the values of the shorter column. The reverse is not true, i.e. Partner.PartnerID is not compatible to Delivery.DocumentID. The DocumentID column is too short to store the 6-character strings of the PartnerID column.

Compatibility may be a technical prerequisite (i.e., a first test) to join the tables. If two columns include the same data type and equal length there is a good enough chance that the two columns are the same. The rule may be relaxed, however, to allow for theoretically more compatible data types. The relaxed rule can be equivalently formulated as: “two columns A and B are compatible if a JOIN ON A=B will work”. For example, there may be cases where a column can be converted to make the column compatible, for example if both columns store the dates, but one in ABAP format “20151224” and one in ISO format “24-12-2015”. In this example, the data type may be different or have a different format, but the subjective information stored therein is the same.

In addition to compatibility, a second prerequisite (i.e., a second test) may be that at least one of the columns be included in a table's primary key. Typically, a foreign key points to the target table's primary key. Hence, column pairs where neither column is in the primary key are irrelevant to foreign key analysis. In the example above, the primary keys are [Client, DocumentID] for Delivery and [Client, PartnerID] for Partner. Although the column Delivery. SupplierID is compatible to Partner.Name, the column is excluded because neither of the two columns are part of a primary key. This technical requirement splits the first step into two steps 1S (for “source”) 410 and 1T (for “target”) 411. Here, step 1S 410 retrieves the primary key of the table under analysis. For each column T in the primary key, the step 1S 410 finds columns S such that S is compatible to T. Colloquial: Find all columns that might point here. Meanwhile, Step 1T 411 retrieves the primary keys of all other tables. For each column T in those keys, the step 1T 411 finds columns S in the table under analysis, such that S is compatible to T. Colloquial: Find all columns here that might point elsewhere. The result lists of these two steps can be simply appended to get the overall result list. As a result, a plurality of columns of the source table may be identified as being compatible with a plurality of respective columns of the target table.

In 420, a single-column inclusion coefficient is calculated. The fact that two columns are technically compatible is only a hint at whether they are really associated. Therefore, to prove that they are related, in 420 the inclusion coefficient between the columns is calculated. The inclusion coefficient is the portion of values that can be found in the other column and may be calculated as shown below:

f(A,B):=1−(|A−B|)/|A| (Equation 1),

where X−Y is an SQL MINUS operation that keeps only those values in X that are not in Y, and |Z| is the number of distinct values in Z. In SQL, this is a statement with basic operators:

f(ta.a, tb.b) = 1 − SELECT COUNT(*) FROM

(SELECT DISTINCT a FROM ta

MINUS
SELECT DISTINCT b FROM tb)

/ SELECT COUNT(*) FROM (SELECT DISTINCT a FROM ta).

For the following tables, as an example, the inclusion coefficient f(Documents.DocumentID, Orders.OrderID) is 0.67: of the three distinct values 0815, 4711, and 9876 in column DocumentID, 67% (2 out of 3) are included in the other column OrderID.

Calculations of this kind are very expensive in traditional row-based relational databases because they require visiting/scanning all rows. The calculations become less expensive if there is an index on the column, but indexes are mostly available on key columns, and the selection of columns according to various embodiments is not limited to these key columns.

According to various embodiments, the database used to store the tables may be a column and dictionary based database that may be used to identify foreign keys included within tables. That is, various features of the column- and dictionary-based database may be exploited. First, the database may store data column-wise, such that access to columns A and B does not require accessing other columns in those tables. Second, the database may store the columns in a sorted and compressed format, with a dictionary on top. The dictionary may include a list of the distinct values in a column. Therefore, to calculate the number of distinct values in the column, the database only needs to return the dictionary's length, without retrieving any data at all. Similarly, the MINUS operation on lists of distinct values may be performed significantly faster in comparison to performing the operation on the actual data which can oftentimes include a large amount of duplicates. The foreign key learner according to various embodiments may be executed in other database management systems, but the foreign key learner may provide more improved performance in systems that use column stores and dictionaries, or likewise techniques. Furthermore, all column pairs that have an inclusion coefficient below a threshold (e.g., 0.98) may be removed. Higher thresholds improve reliability of the found foreign keys. Lower thresholds make the algorithm more tolerant if the raw data is polluted with inconsistent data sets.

The first step in 410 produced a list of pairs of columns that are technically compatible. Each list may include a plurality of columns from the source table that are potentially matches to a plurality of respective columns in the target table. The second step in 420 removed pairs of columns that have values that don't match. Next, in 430 the discoverer removes pairs that are not sufficient to form a full foreign key relation between two tables. In the following example shown in Tables 5 and 6 below, the discoverers first step in 410 identified column Partner.Client that is technically compatible to column ThreadConfiguration.Client. The second step in 420 calculated a perfect inclusion coefficient of 100%, keeping the pair in the list of candidates. However, this pair alone is insufficient to form a foreign key between the tables. To get from Partner to ThreadConfiguration, another column pair that included the key column ThreadID may be used. To get from ThreadConfiguration to Partner, another column pair that included the key column PartnerID may be used. As a result, the column pair is worthless and can be removed.

In 430, the column pairs are divided into groups with the same source and target table. Then for each group whether the group contains a column pair for each key column of the target table may be verified, and if this is not the case, the group is removed. Step 430 can also be repeated earlier between steps 1 and 3 to reduce the number of single-column inclusion coefficients that need to be calculated.

Most tables have more than one key column. In 440, the discoverer expands the list of column pairs produced by the previous steps into all possible combinations for multi-column keys. For example, the following two tables (Tables 7 and 8) led to the following list of column pairs: {(Document. Client, Reference.Client), (Document.InternalID, Reference.ReferenceID), (Document.ExternalID, Reference.ReferenceID)}. In other words, the algorithm is unsure whether InternalID or ExternalID points to ReferenceID. As a result, both need to be looked at. This step therefore produces two combinations: ([Document. Client, Document.InternalID], [Reference. Client, Reference.ReferenceID]) and ([Document. Client, Document.ExternalID], [Reference. Client, Reference.ReferenceID]).

For each of the combinations produced in 440, the discoverer may calculate the multi-column inclusion coefficient, in 450. This calculation is similar to the calculation in 420, with the exception that this time, multiple columns are considered. Furthermore, combinations that have inclusion coefficient under a given threshold are removed. The remaining combinations form the final result of the foreign key discoverer 331.

Tables 9 and 10 demonstrate that single-column and multi-column inclusion coefficients can be very different. The column pairs Document.Client and ForeignDocument.Client as well as Document.DocumentID and ForeignDocument.DocumentID have perfect single-column inclusion coefficients in either direction. However, the multi-column inclusion coefficients between [Document. Client, Document.DocumentID] and [ForeignDocument.Client, ForeignDocument.DocumentID] are zero in both directions, hence contradicting a foreign key relation.

Referring again to FIG. 3, discoverer 332 discovers foreign keys based on system views. For example, most advanced database management systems allow creating constraints that ensure consistency of the data. For example, a constraint may state that a certain column in a table may not contain the special value NULL. Referential constraints are a special kind of such constraints that specify how the data of two tables may or may not relate to each other. The most common use case is to specify that two tables are related with a foreign key. Referential constraints cause the database management system to insert new rows into the dependent/source table only if they point to existing rows in the parent/target table. The constraints may also be specified as cascading deletes. In this example, when deleting a row in the parent/target the operation automatically deletes all related rows in the dependent/source table. In other words, the database already offers metadata on existing foreign key relations that only needs to be harvested. The system-view-based discoverer 332 retrieves foreign keys from the database's metadata layer and returns them.

Referring again to FIG. 3, a data dictionary based discoverer 333 of the foreign key learning process may detect foreign keys based on a data dictionary associated with one or more tables. According to various embodiments, the data tables may be stored in a database that uses a data dictionary (DDIC) in an application layer to store foreign key relations. The data dictionary based discoverer 333 may read this metadata and return the found relationships. Unfortunately, this metadata is incomplete and may only provide a partial view of the relationships. For example, relationships that are not active or only seldom used by the applications are often implemented in the code, but not modelled anywhere in the data dictionary. Some of these relations are so implicit that their developers may not even be aware of them. Some applications, replicate database tables from multiple source systems into their own database. This allows the application to cross organizational and technical borders, in this case to detect fraud across multiple systems. The data is usually separated by using a respective schema per source system. In this type of example, the system may not only replicate the business data, but also replicate the metadata tables including the database tables that make up the data dictionary to gain access to the metadata in the source systems. The data-dictionary-based discoverer 333 can then look up multiple data dictionaries from the corresponding database and from other databases.

Another discoverer included in the process 300 is the discoverer from other systems 334. Typically, an application is processed on a multitude of systems. For example, an application may be executed in a development system, a test system, and a production system. As another example, a global customer runs the same application in multiple systems for different subsidiaries. In this case, the foreign key learners can learn from each other. Learned relationships of foreign keys can be pushed to other learners as described in 360, or they can be pulled as described here. The discoverer from other systems 334 calls one or more other systems to ask their foreign key learners about their findings regarding a given table. For example, the discoverer 334 may send the table's name, and the names and data types of columns. In response, the learner compares this specification to the tables in its own database. If there is a match, the learner may retrieve all known table relations and send them back to the discoverer 334.

In some cases, the learner may decide to not compare the table specification if the learner detects that the discoverer is running on the same data sources. This may be true, for example, if a development system and a test system for the same application communicate to each other; as both run the same application in the same version, with the same data sources, thus there is no need to compare the tables. In some cases, the learner may accept soft matches. When doing this, a lower quality of a match may be signaled to the discoverer. For example, if the learner cannot find 1 out of 57 columns, but the rest matches, this may indicate that the discoverer is running a different version of the same application. While there may be differences between the versions, chances are high that the discoverer can still reuse many of the learner's findings. Hence, the learner may decide to accept the match and send the findings back. The low-match signal tells the discoverer 334 not to accept these findings blindly, but validate them before submitting them to memory. Also, the discoverer 334 may trust or distrust learners in other systems. When trusting a learner from another system, the discoverer 334 may save returned table relations immediately, without further validation, unless the learner explicitly indicates to do this. When distrusting a learner, the discoverer 334 may always validate the returned results; moreover, the discoverer 334 may also choose to inform other discoverers that they should check the table anyway. Furthermore, the discoverer 334 can validate received table relations by calculating their multi-column inclusion coefficients and rejecting relations that do not reach a specified threshold.

So far, all discoverers 331-334 have operated locally, or within the boundaries of an organizational network. The cloud-based discoverer 335 goes beyond this, and pulls learnings from a cloud storage environment. The cloud-based discoverer 335 works very similar to the discoverer from other systems 334 that discovers table relations from other systems. The main difference is that this one contacts a cloud system to retrieve known relations. Once the foreign keys of an application have been learned at anytime, anywhere in the world, there is no need to learn this relationship again (save for version changes). If the foreign key learner shares findings with the cloud, the cloud may share the findings with other foreign key learners, and large quantities of computation time can be saved on a global basis. Furthermore, the quality of findings can be raised because the cloud may introduce further attributes to the table relations that allow the cloud to store the reliability of a finding, and the finding's usefulness to business users.

For example, learner A may find a table relationship (i.e., a foreign key) between tables X and Y, and share this with the cloud. The calculated multi-column inclusion coefficient may be low, e.g., only 95%. However, human users subsequently confirmed that the table relation is correct, and the low coefficient was only due to some inconsistent data. At the same time, business users stated that, although the table relation is correct, the table relation is also of low business value, and generally not of interest. The cloud may receive and save all of this, and share the information with other learners asking for tables X or Y. These learners thus get much more information than only the pure possible existence of the table relation. Furthermore, the cloud-based foreign key learner could be expanded into a fully-fledged content store. Similar to Apple's App Store, the content store may distribute or sell business content and configurations for applications including learned foreign keys making the content easier to process.

For example, customer A replicates a new table InvoiceItems into a Fraud Management application. In this example, a local foreign key learner is triggered and contacts the cloud. Through a subscription contract, the foreign key learner accesses table relations regarding the new table, and stores them. The user can now immediately use these new table relations. The subscription contract authorizes the foreign key learner to distribute these findings to other foreign key learners in his local network. The foreign key learner also does some local learning, and tells the cloud that another, so far unknown table relation has been found. The cloud saves this relation and may provide the customer a discount for future transactions as a bonus. At the same time, the content store has become aware that the customer is doing something with the InvoiceItems table. A suggestion module identifies other business and configuration content related to this table. As a result, the suggestion module may send customer A an e-mail that offers further content, such as rules for fraud detection, user interfaces that display the new table's contents, data cubes for analytical purposes, and a list of certified partners that may help implementing custom solutions.

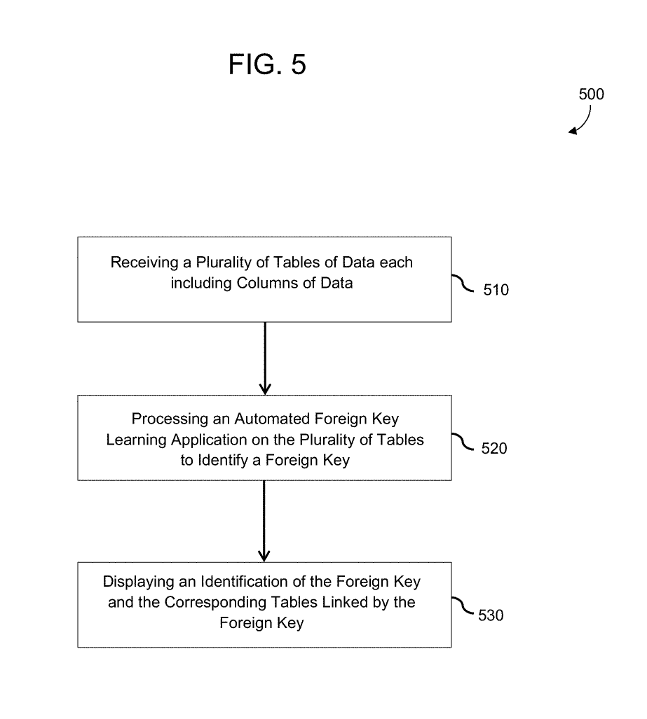

FIG. 5 illustrates a method 500 for detecting a foreign key in accordance with example embodiments. For example, the method 500 may be performed by the foreign key learning application 210 shown in FIG. 2 based on one or more foreign key discovery operations. Referring to FIG. 5, in 510 the method includes receiving a plurality of tables of data. Here, each table of data may include plurality of columns of data each having a plurality of rows included therein. The tables of data may be stored in a column based and dictionary based database and be operated on by various software applications.

In 520, the method further includes processing an automated foreign key learning application with respect to the plurality of tables to identify at least one foreign key that links a list of columns of a first table to a list of columns of a second table, from among the plurality of tables. The processing may identify many foreign keys between two tables among a large group of tables. In other words, the processing 520 may be performed on a large number of tables simultaneously and identify foreign keys associated with each of the respective tables. In 530, the method includes displaying a user interface including an identification of the at least one foreign key, the first table and the second table associated with the at least one foreign key. In some embodiments, the method also includes determining a confidence rating indicating a likelihood that the foreign key exists between the columns of the first table and the columns of the second table, and the outputting further includes displaying the confidence rating.

According to various embodiments, the processing performed in 520 may include one or more discovery operations that are each configured to analyze data and find foreign keys based on a respective algorithm thereof. For example, the processed automated foreign key learning application may identify the foreign key by comparing a data type and a length of each column of the first table to a data type and a length of each column of the second table to determine a list of columns of the first table and a list of columns of the second table are compatible with each other. In response to the data type and the length of each of the columns being compatible with each other, the foreign key learning application may further identify the foreign key by calculating an inclusion coefficient between the column of the first table and the column of the second table based on data included in the column of the first table and data included in the column of the second table.

The foreign key learner may also determine foreign keys using one or more other discovery operations. For example, the processed automated foreign key learning application may identify the foreign key by determining that at least one of the column of the first table and the column of the second table is included in a primary key of a respective table. As another example, the processed automated foreign key learning application may identify the foreign key based on referential constraint metadata associated with the first and second table. As another example, the processed automated foreign key learning application may identify the foreign key based on data dictionary metadata associated with the first and second table. As another example, the processed automated foreign key learning application may identify the foreign key by calling one or more other systems and requesting foreign key information about at least one of the first table and the second table. Here, the one or more other systems that are called by the foreign key learning application may include a cloud-based system.

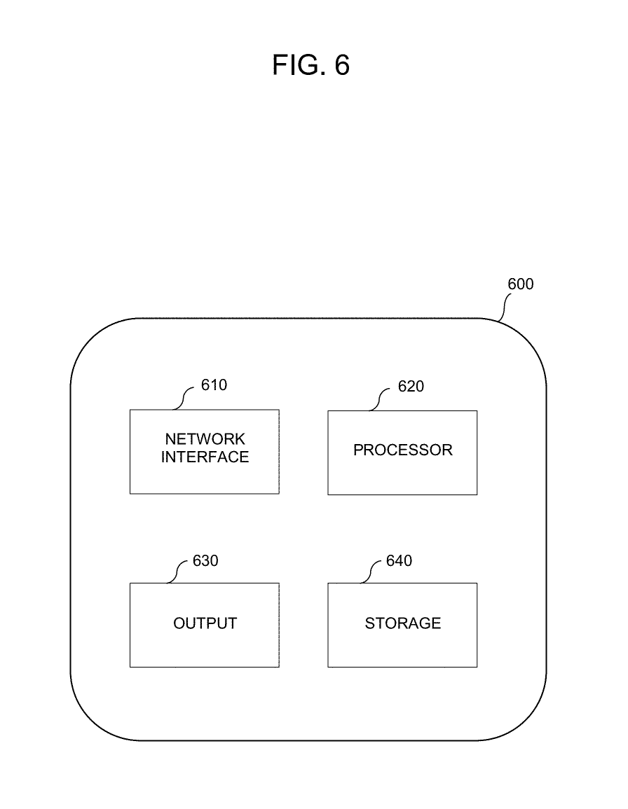

FIG. 6 illustrates a device 600 for detecting a foreign key among tables of data in accordance with example embodiments. For example, the device 600 may process the foreign key learning application described herein. Also, the device 600 may perform the methods of FIGS. 3, 4, and 5. Referring to FIG. 6, the device 600 includes a network interface 610, a processor 620, an output 630, and a storage device 640. Although not shown in FIG. 6, the device 600 may include other components such as a display, an input unit, a receiver/transmitter, and the like. The network interface 610 may transmit and receive data over a network such as the Internet, a private network, a public network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or the processor 620 may be reconfigurable. The output 630 may output data to an embedded display of the device 600, an externally connected display, a cloud, another device, and the like. The storage device 640 is not limited to any particular storage device and may include any known memory device such as RAM, ROM, hard disk, and the like.

According to various embodiments, the processor 620 may execute various software applications on data included in tables of the storage 640 or in another storage. The applications may be configured to operate on unknown data, thus making data processing difficult. In order to improve data processing, the processor 620 may execute the foreign key learner to identify relationships between the underlying data. In this example, the processor 620 may receive a plurality of tables of data from the storage 640 or from an external storage (not shown), and process, via one or more processing devices included in the processor 620, an automated foreign key learning application with respect to the plurality of tables to identify at least one foreign key that links a list of columns of a first table to a list of columns of a second table, respectively. The output 630 may display a user interface including an identification of the foreign key, the first table, and the second table. The display may be output to a display screen embedded on the device 600 or on an externally connected display. In operation, the processor 620 may receive a name of a database table and process a plurality of foreign key discoverers on the database table to identify all foreign keys (e.g., where the database table is either a source table, a target bale, or both) associated with the database table.

For example, based on a first discoverer the processor 620 may identify a foreign key by comparing a data type and a length of the column of the first table to a data type and a length of the column of the second table to determine if the column of the first table and the column of the second table are compatible with each other. In this case, if the two columns are compatible, the processor 620 may further identify the foreign key by calculating an inclusion coefficient between the column of the first table and the column of the second table based on data included in the column of the first table and data included in the column of the second table. The processor 620 may also determine a confidence rating indicating a likelihood that the foreign key exists between the column of the first table and the column of the second table, and the output 630 may further display the confidence rating.

As another example, based on another discoverer the processor 620 may identify a foreign key by determining that at least one of a column of a first table and a column of a second table is included in a primary key of a respective table. As another example, based on another discoverer the processor 620 may identify a foreign key based on referential constraint metadata associated with the first and second table. As another example, based on another discoverer the processor 620 may identify a foreign key based on data dictionary metadata associated with the first and second table. As another example, based on another discoverer the processor 620 may identify a foreign key by calling one or more other systems and requesting foreign key information about at least one of the first table and the second table. In this example, the one or more other systems that are called by the processor 620 may include a cloud-based system.

The example embodiments are directed towards an automated foreign key learning application capable of detecting a foreign key that links two tables of data. The automated foreign key learner may include a plurality of foreign key discovery modules that are capable of identifying foreign keys simultaneously or sequentially from the tables of data. Furthermore, the identified foreign key relationships can be shared with other systems and devices that operate on the data making the processing of the data easier.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A device for detecting foreign keys, the device comprising:
a processor configured to receive a plurality of tables of data, and identify a foreign key between a first table and a second table by comparing a data type and a length of a column of the first table to a data type and a length of a column of the second table, respectively, to determine whether the column of the first table and the column of the second table are compatible, and calculating an inclusion coefficient between the column of the first table and the column of the second table based on data included in the respective columns; and
an output configured to display a user interface comprising an identification of the foreign key, the first table, and the second table.

2. The device of claim 1, wherein the processor is further configured to identify the foreign key by comparing a data type and a length of a list of columns of the first table to a data type and a length of a list of columns of the second table, respectively, to determine whether the list of columns of the first table and the list of columns of the second table are compatible with each other, respectively.

3. The device of claim 2, wherein the processor is further configured to identify the foreign key by calculating an inclusion coefficient between the list of columns of the first table and the list of columns of the second table based on data included in the list of columns of the first table and data included in the list of columns of the second table, respectively.

4. The device of claim 1, wherein the processor is further configured to identify the foreign key by determining that at least one of the column of the first table and the column of the second table is included in a primary key of a respective table.

5. The device of claim 1, wherein the processor is further configured to identify the foreign key based on referential constraint metadata associated with the first and second table.

6. The device of claim 1, wherein the processor is further configured to identify the foreign key based on data dictionary metadata associated with the first and second table.

7. The device of claim 1, wherein the processor is further configured to identify the foreign key by calling one or more other systems and requesting foreign key information about at least one of the first table and the second table.

8. The device of claim 1, wherein the one or more other systems that are called by the foreign key learning application include a cloud-based system.

9. The device of claim 1, wherein the processor is further configured to determine a confidence rating indicating a likelihood that the foreign key exists between the column of the first table and the column of the second table, and the output is further configured to display the confidence rating.

10. A method for detecting foreign keys, the method comprising:
receiving a plurality of tables of data;
processing, via one or more processing devices, an automated foreign key learning application comprising at least one foreign key discovery operation, with respect to the plurality of tables, to identify a foreign key that links a list of columns of a first table to a list of columns of a second table, from among the plurality of tables; and
displaying a user interface comprising an identification of the foreign key, the first table, and the second table.

11. The method of claim 9, wherein the processing comprises identifying the foreign key by comparing a data type and a length of the list of columns of the first table to a data type and a length of the list of columns of the second table to determine if the list of columns of the first table and the list of columns of the second table are compatible with each other.

12. The method of claim 10, wherein the processing comprises identifying the foreign key by calculating an inclusion coefficient between the list of columns of the first table and the list of columns of the second table based on data included in the list of columns of the first table and data included in the list of columns of the second table.

13. The method of claim 9, wherein the processing comprises identifying the foreign key by determining that at least one of the list of columns of the first table and the list of columns of the second table are included in a primary key of a respective table.

14. The method of claim 9, wherein the processing comprises identifying the foreign key based on referential constraint metadata associated with the first and second table.

15. The method of claim 9, wherein the processing comprises identifying the foreign key based on data dictionary metadata associated with the first and second table.

16. The method of claim 9, wherein the processing comprises identifying the foreign key by calling one or more other systems and requesting foreign key information about at least one of the first table and the second table.

17. The method of claim 9, wherein the one or more other systems that are called by the foreign key learning application include a cloud-based system.

18. The method of claim 9, wherein the processing further comprises determining a confidence rating indicating a likelihood that the foreign key exists between the list of columns of the first table and the list of columns of the second table, and the outputting further comprises displaying the confidence rating.

19. A non-transitory computer readable medium having stored therein instructions that when executed cause a computer to perform a method for detecting foreign keys, the method comprising:
receiving a plurality of tables of data;
processing, via one or more processing devices, an automated foreign key learning application comprising at least one foreign key discovery operation, with respect to the plurality of tables to identify a foreign key that links a list of columns of a first table to a list of columns of a second table, from among the plurality of tables; and
displaying a user interface comprising an identification of the foreign key, the first table, and the second table.

20. The non-transitory computer-readable medium of claim 19, wherein the processing comprises identifying the foreign key by comparing a data type and a length of the list of columns of the first table to a data type and a length of the list of columns of the second table to determine if the list of columns of the first table and the list of columns of the second table are compatible with each other, respectively.
